(19) United States
(12) Patent Application Publication
(10) Pub. No.: US 2014/0043347 A1
(43) Pub. Date: Feb. 13, 2014

(54) METHODS FOR JPEG2000 ENCODING AND DECODING BASED ON GPU

(71) Applicant: Electronics and Telecommunications Research Institute, Daejeon (KR)

(72) Inventors: Jeong-Woo LEE, Daejeon (KR); Bum-Ho KIM, Daejeon (KR); Jin-Wuk SEOK, Daejeon (KR); Jung-Soo LEE, Daejeon (KR); Yeon-Jeong JEONG, Daejeon (KR); Ki-Song YOON, Daejeon (KR)

(21) Appl. No.: 13/906,298

(22) Filed: May 30, 2013

(30) Foreign Application Priority Data
Aug. 10, 2012 (KR) 10-2012-0087867

(51) Int. Cl. G06T 1/20

(52) U.S. Cl. CPC G06T 1/20
USPC 345/522

(57) ABSTRACT

Methods for Joint Photographic Experts Group (JPEG) 2000 encoding and decoding based on a graphic processing unit (GPU) are provided. The method for JPEG2000 encoding based on a GPU includes receiving input image data from a central processing unit (CPU), encoding the image data, and transferring the encoded image data to the CPU.

### CROSS-REFERENCE TO RELATED APPLICATION

This application claims the benefit under 35 U.S.C. §119(a) of a Korean Patent Application No. 10-2012-0087867, filed on Aug. 10, 2012, the entire disclosure of which is incorporated herein by reference for all purposes.

### BACKGROUND

1. Field

The following description relates to digital cinema image processing technology, and more particularly, to methods for Joint Photographic Experts Group (JPEG) 2000 encoding and decoding based on a graphic processing unit (GPU).

2. Description of the Related Art

A digital cinema standard uses a JPEG2000 algorithm to compress high-capacity images. The JPEG2000 algorithm is based on wavelet transform, unlike JPEG/Moving Picture Experts Group (MPEG) based on discrete cosine transform (DCT). Wavelet transform uses an entire screen as a basic encoding unit, unlike DCT which uses an 8×8 or 4×4 block as a basic unit.

Meanwhile, a GPU that has handled screen rendering in an existing personal computer (PC) is currently being regarded as an arithmetic processor, like a central processing unit (CPU).

Basically, a GPU optimizes throughput using a very large number of threads. In a hardware aspect, there are many runnable threads. Thus, while some threads are waiting for memory access for a long delay time, other threads perform operation, thereby minimizing control logics. However, a GPU is not designed to perform operations in which a CPU shows superior performance, but designed as an arithmetic operation engine. Thus, it is necessary for most application programs to be designed to use a CPU and a GPU at the same time, so that the CPU performs a sequential part and a logical part, and the GPU performs a part involving a large amount of calculation.

A GPU provides a global memory and a shared memory, and it takes 150 times more time to access the global memory than to access the shared memory. Thus, it is important on how to use a limited shared memory for performance improvement. In a GPU, data input or output (from a global memory to a shared memory or vice versa) and running of a thread in a block are performed in warp units (generally 32 threads), and thus it is also important to run threads numbering a multiple of a warp unit for performance improvement.

### SUMMARY

The following description relates to a method capable of processing Joint Photographic Experts Group (JPEG) 2000 encoding or decoding methods at high speed using a central processing unit (CPU) and a graphic processing unit (GPU).

In one general aspect, a method for JPEG2000 encoding based on a GPU includes: receiving input image data from a CPU; encoding the image data; and transferring the encoded image data to the CPU.

In another general aspect, a method for JPEG2000 decoding based on a GPU includes: receiving preprocessed image data from a CPU; decoding the received image data; and transferring the decoded image data to the CPU.

Other features and aspects will be apparent from the following detailed description, the drawings, and the claims.

### BRIEF DESCRIPTION OF THE DRAWINGS

FIG. 1 is a flowchart illustrating a method of encoding an image using a graphic processing unit (GPU) according to an embodiment of the present invention.

FIG. 2 is a flowchart illustrating detailed operations of component decomposition according to an embodiment of the present invention.

FIG. 3 is a flowchart illustrating detailed operations of wavelet transform according to an embodiment of the present invention.

FIG. 4 is a flowchart illustrating a method of decoding an image using a GPU according to an embodiment of the present invention.

FIG. 5 is a flowchart illustrating detailed operations of component combination according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

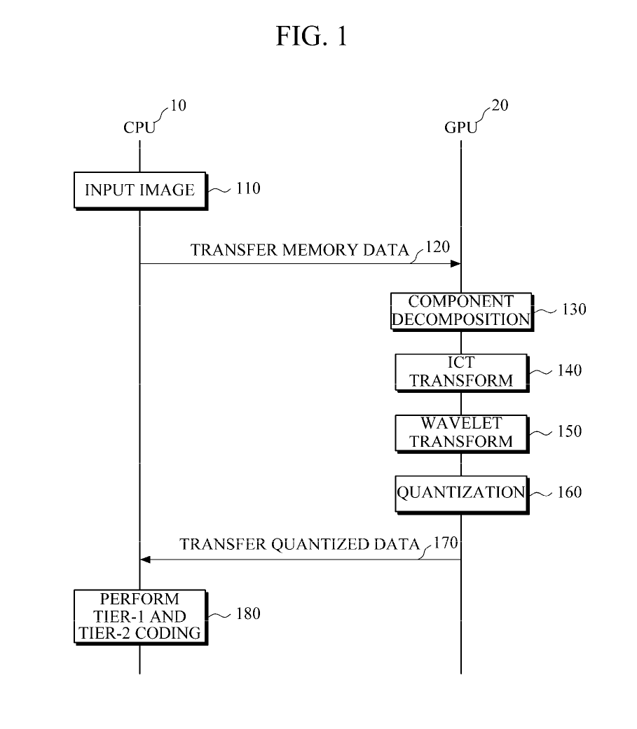

FIG. 1 is a flowchart illustrating a method of encoding an image using a graphic processing unit (GPU) according to an embodiment of the present invention.

Referring to FIG. 1, a central processing unit (CPU) 10 receives image data in operation 110, and stores the image data in a memory therein. Here, the image data may be input from an internal or external camera, or acquired from a storage of a device run by the CPU 10, or from the outside through communication. In general, image data may be a red, green and blue (RGB) signal or a YUV signal in pixel units. The CPU 10 transfers the image data stored in the CPU memory in operation 120 to a GPU memory.

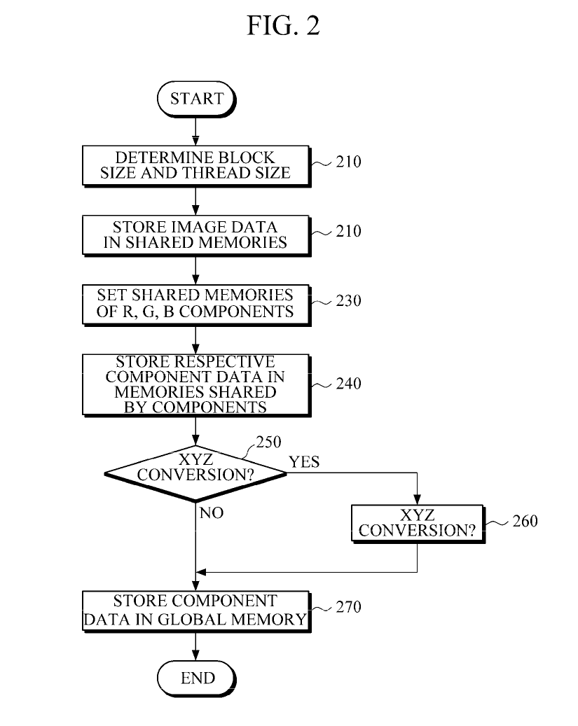

Then, in operation 130, a GPU 20 decomposes the image data into components. In general, image data stored in the GPU memory is data in the form of RGB in pixel units. In operation 130, the GPU 20 decomposes such image data in pixel units into data consisting of respective components of R, G and B. At this time, GPU multi-core technology is employed. If XYZ conversion is necessary, an XYZ conversion operation may be performed before the image data is stored as R, G and B components. In the case of digital cinema, image data may be finally classified into an X component, a Y components and Z component through XYZ conversion. Component decomposition of operation 130 will be described in further detail later is with reference to FIG. 2.

In operation 140, the GPU 20 performs irreversible color transform (ICT), thereby converting the image data stored in the GPU memory into the respective components of the image data. Like YUV transform, ICT is transformation of a color space for performing wavelet transform more efficiently.

In operation 150, the GPU 20 performs wavelet encoding of the data that has been subjected to ICT and is present in the GPU memory. Wavelet encoding is an operation of encoding the respective X, Y and Z components using a wavelet encoding algorithm. Specifically, original data x(m, n) is divided into pieces of data y11(m, n), y12(m, n), y21(m, n), and y22(m, n) through wavelet encoding. These are referred to as LLR-1 band data, LHR-1 band data, HLR-1 band data, and HHR-1 band data, respectively. According to characteristics of wavelet encoding, LLR-1 band data is image data whose width and height are half those of the original image data. Through the aforementioned wavelet encoding process, the LLR-1 band data may be divided again into four pieces of data, that is, LLR-2 band data, LHR-2 band data, HLR-2 band data, and HHR-2 band data. In other words, wavelet encoding may be repeated several times.

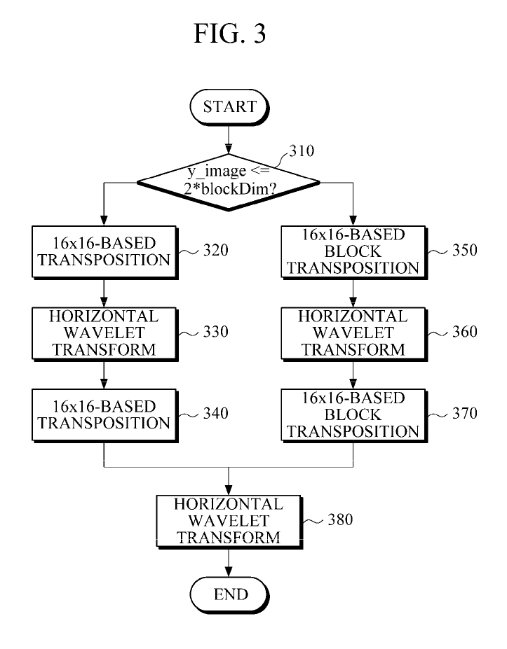

For example, wavelet encoding may be repeatedly performed on 2K image data of digital cinema five times, and repeatedly performed on 4K image data six times. Such wavelet encoding will be described in further detail later with reference to FIG. 3.

In operation 160, the GPU 20 quantizes the wavelet-encoded image data present in the GPU memory. Quantization is an operation of dividing encoded image data according to a predetermined value. In the case of non-compression, a quantization parameter is 1. In operation 170, the GPU 20 transmits the quantized image data to the CPU 10.

Then, in operation 180, the CPU 10 performs Tier-1 and Tier-2 coding, to which CPU multi-threading technology is applied, of the quantized image data present in the CPU memory, thereby generating final compressed data.

According to layers and bands, the Tier-1 coding process is separately performed on the quantized image data in parallel. Tier-1 coding is an operation of encoding the respective components using an embedded block coding with optimized truncation (EBCOT) algorithm, in which LHR-1 data is encoded using LHR-2 data information, HLR-1 data is encoded using HLR-2 data information, and HHR-1 data is encoded using HHR-2 data information. In a Tier-2 coding operation, the data encoded in the Tier-1 operation is converted into an actual coding stream. Processes of the CPU 10 and the GPU 20 are performed separately from each other. In other words, while the data is processed in operation 180, the GPU 20 processes the next frame data.

FIG. 2 is a flowchart illustrating detailed operations of component decomposition according to an embodiment of the present invention.

The size of image data stored in a CPU memory may be expressed as (x_image×y_image). Image data transferred to a GPU 20 has a size of (x_stride×y_image) larger than image_x, and is copied to a one-dimensional (1D) GPU global memory. Here, the size of x_stride is a multiple of 256 or 512, and the GPU global memory can be accessed by all kernel functions performed in the GPU 20. However, reading and writing speeds of the global memory are about 150 times slower than those of the shared memory that can be accessed in only one kernel.

In operation 210, the GPU 20 determines block and thread sizes for executing a GPU kernel. The number of threads is determined to be a multiple of a warp size within the maximum number of threads allowed by the GPU 20. The number of blocks is determined to be a value obtained by dividing the whole size by (thread size(blockDim)*3). In this case, one kernel processes data having a size of (blockDim*3), and as many kernels as the number of blocks are run by a GPU scheduler.

In operation 220, the GPU 20 stores image data that is stored in the global memory and has a size of (blockDim×3) in a shared memory to increase speed in a kernel. In operation 230, the GPU 20 sets shared memories, that is, cx, cy and cz, for storing R, G and B component data in a kernel. The size of each of cx, cy and cz is blockDim.

In operation 240, using blockDim and a current thread identifier (ID), the GPU 20 stores respective pieces of R, G and B component data stored in the shared memory in cx, cy and cz, respectively. The component data is stored in cx when a remainder of dividing threadId, blockDim+threadId, or 2*blockDim+threadId by 3 is 0, stored in cy when the remainder is 1, and stored in cz when the remainder is 2.

In operation 250, the GPU 20 determines whether XYZ conversion is necessary for the R, G and B component data. When it is determined in operation 250 that XYZ conversion is necessary, the GPU 20 performs XYZ color conversion of the R, G and B component data stored in the shared memories in operation 260.

On the other hand, when it is determined in operation 250 that XYZ conversion is unnecessary for the R, G and B component data, or after operation 260, the GPU 20 stores the component data stored in the shared memories in the global memory and finishes component decomposition in operation 270.

FIG. 3 is a flowchart illustrating a wavelet transform method.

Wavelet transform used in image compression is 2D transform, and thus 1D transform is performed in the vertical direction first and then in the horizontal direction. To use multiple threads of a GPU, vertical wavelet transform uses a method of transposing data first, performing horizontal wavelet transform, and then transposing the wavelet-transformed data back to the original data.

Referring to FIG. 3, in operation 310, the GPU 20 determines whether or not a y-axis size of data that will be subjected to wavelet transform is 2*blockDim or less. When it is determined in operation 310 that the size of y_image is 2*blockDim or less, the GPU 20 transposes the data in 16×16 units in operation 320 because the GPU 20 shows the best performance when it reads data in warp units, unlike in CPU memory access.

Since the size of y_image is less than 2*blockDim, operation 320 is performed with no conditional statement. The result of transposition is stored in a global memory of a multiple of 32 that is greater than an original data size to minimize non-coalescence in a wavelet transform process.

In operation 330, to process data (y_image×x_image), the size of a shared memory and the size of a block are determined to be y_image and x_image, respectively. Using the shared memory, wavelet transform (split operation and lifting operation) is performed.

In operation 340, the wavelet-transformed data is transposed back and stored in the global memory in which an original image has been stored.

Meanwhile, when it is determined in operation 310 that the size of the data that will be subjected to wavelet transform is greater than 2*blockDim, the GPU 20 performs transposition in the same way as in operation 320, but does not transpose data outside the interface of a block.

In operation 360, the number of threads and the number of blocks are determined like in operation 330, but operation is performed on one thread ID two times in one kernel because the size of y_image is greater than the number of threads runnable by the GPU 20 at one time.

In operation 370, the wavelet-transformed data is transposed back and stored in the global memory in which the original image has been stored.

In operation 380, the data (x_image×y_image) is not subjected to a transposition process, but operations 320 to 370 are performed according to a case in which the size of x_image is less than 2*blockDim, or a case in which the size of x_image is greater than 2*blockDim.

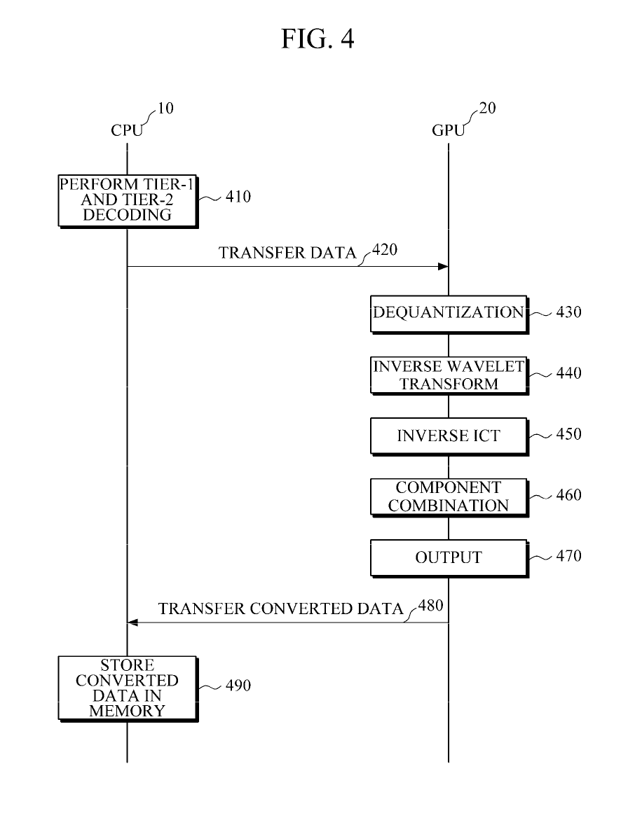

FIG. 4 is a flowchart illustrating a method of decoding an image using a GPU according to an embodiment of the present invention.

Referring to FIG. 4, in operation 410, a CPU 10 performs a Tier-2/1 decoding process on data stored in a CPU memory by employing CPU multi-threading technology. According to layers and bands, the Tier-1 decoding process is separately performed on the data.

In operation 420, the CPU 10 transfers the data present in the CPU memory to a global memory of a GPU 20 to use multiple cores of the GPU 20. Then, in operation 430, the GPU 20 performs dequantization of the data in the GPU memory.

In operation 440, the GPU 20 performs inverse wavelet transform on the data in the GPU memory on the basis of the multiple cores of the GPU 20. In operation 450, an inverse ICP process is performed on the data in the GPU memory on the basis of the multiple cores of the GPU 20.

In operation 460, the GPU 20 transforms respective pieces of R, G and B component data present in the GPU memory into the form of RGB. When RGB conversion is necessary, a transform operation is performed before data is stored as RGB data. The transformed data is directly output from the GPU memory to a screen not via the CPU memory when a serial digital interface (SDI) or screen output is necessary, and transferred to the CPU memory when storage is necessary.

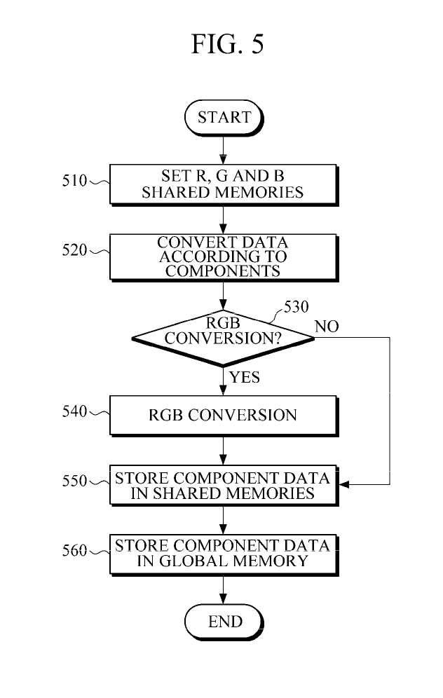

FIG. 5 is a flowchart illustrating detailed operations of component combination according to an embodiment of the present invention.

In operation 510, a GPU 20 sets shared memories for respectively storing pieces of R, G and B component data. Each memory size is set to a multiple of a warp size, and to be smaller than a value obtained by dividing the maximum shared memory size usable in one kernel. For example, when the maximum size of a shared memory is 16,000 bytes, and one piece of data consists of four bytes, the size of the shared memory block is set to 256. Data in a global memory is stored in the shared memories. Since the data is read from the global memory in warp units, non-coalescence does not occur.

In operation 520, the GPU 20 processes the component data in the shared memories for screen output or storage. In operation 530, the GPU 20 determines whether RGB conversion is necessary for data output or storage.

When it is determined in operation 540 that RGB conversion is necessary, RGB conversion is performed using multiple cores of the GPU 20 in operation 540. In operation 550, the GPU 20 stores the component data stored in the respective shared memories in the shared memories in order of RGB. Here, the size of the shared memories for storing the RGB data may be 256×3.

In operation 560, the GPU 20 stores the RGB data stored in the shared memories in the global memory. Since the data has already been stored in the shared memories in sequence, non-coalescence does not occur in a process of writing the data in the global memory.

In embodiments of the present invention, wavelet-based Joint Photographic Experts Group (JPEG) 2000 encoding and decoding methods are performed using GPU multi-cores and CPU multi-cores, and thus a system employing JPEG2000 can be implemented at low cost. Also, it is possible to minimize cases in which a module employing GPU multi-cores causes reduction in the speed of a GPU system.

The present invention can be implemented as computer readable codes in a computer readable record medium. Computer readable record media include all types of record media in which computer readable data is stored. Examples of computer readable record media include a ROM, a RAM, a CD-ROM, a magnetic tape, a floppy disk, and optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for Joint Photographic Experts Group (JPEG) 2000 encoding based on a graphic processing unit (GPU), comprising:
receiving input image data from a central processing unit (CPU);
encoding the image data; and
transferring the encoded image data to the CPU.

2. The method of claim 1, wherein the encoding of the image data includes:
decomposing the image data according to red, green and blue components;
performing wavelet transform of the decomposed component data; and
quantizing the wavelet-transformed data.

3. The method of claim 2, wherein the performing of the wavelet transform is repeated several times according to a size of the image data.

4. The method of claim 2, wherein the decomposing of the image data includes:
determining a number of blocks and a thread size;
storing the image data stored in a global memory in shared memories set according to the components; and
storing the image data stored in the shared memories in the global memory.

5. The method of claim 4, further comprising:
determining whether XYZ conversion is necessary; and
when XYZ conversion is necessary, performing XYZ color conversion of the component data stored in the shared memories.

6. The method of claim 2, wherein the performing of the wavelet transform includes:
transposing the image data in 16×16 units;
performing wavelet transform using a shared memory; and
transposing the wavelet-transformed data back and storing the original data in a global memory in which an original image has been stored.

7. A method for Joint Photographic Experts Group (JPEG) 2000 decoding based on a graphic processing unit (GPU), comprising:
receiving preprocessed image data from a central processing unit (CPU);
decoding the received image data; and
transferring the decoded image data to the CPU.

8. The method of claim 7, wherein the decoding of the received image data includes:
performing dequantization of the image data;
performing inverse wavelet transform on the dequantized image data; and
combining inverse-wavelet-transformed respective pieces of red, green and blue component data into a pixel format.

9. The method of claim 8, wherein the combining of the inverse-wavelet-transformed respective pieces of red, green and blue component data includes:
setting shared memories for storing the respective pieces of component data;
processing the component data in the shared memories for screen output or storage; and
storing the processed component data in a global memory.
